(19) United States
(12) Patent Application Publication
(10) Pub. No.: US 2007/0266893 A1
(43) Pub. Date: Nov. 22, 2007

(54) COMPOSITE PLATE

(76) Inventor: TAT WING SO, Hong Kong (HK)

Correspondence Address: J.C. PATENTS, SUITE 250, 4 VENTURE, IRVINE, CA, 92618, US

(21) Appl. No.: 11/779,193

(22) Filed: Jul. 17, 2007

Related U.S. Application Data
(63) Continuation of application No. PCT/CN2005/000119, filed on Jan. 27, 2005.

(51) Int. Cl. C08L 97/02; B32B 3/28

(52) U.S. Cl. 106/164.1; 428/184

(57) ABSTRACT

A composite plate includes one or more composite layers, which is made of sawdust, cullet, and plastic and the raw material may be all kinds of recycled waste wood and waste plastic.

### CROSS-REFERENCE TO RELATED APPLICATION

This is a continuation of international application PCT/CN2005/000119, with an international filing date of Jan. 27, 2005, now abandoned, the contents of which is hereby incorporated by reference in its entirety.

### FIELD OF THE INVENTION

This invention relates to a plate, particularly to a composite plate made of recycled materials.

### BACKGROUND OF THE INVENTION

Numerous plates are used in various applications, such as building and fitting-up of a house. However, the above applications and other industrial processes produce lots of waste plastic, wood and glass, etc. The wastes are often transported to tipped fill regions and then are disposed of as being useless garbage, which will take a large amount of expenses and result in waste of materials and pollution when the wastes are subjected to simple disposals. As the environmental protection is increasingly realized by the people, how to change wastes into valuables becomes a goal of research.

The inventor of the present invention is devoted to make a new composite material by processing said wastes, which composite material can be used in various applications requiring plates.

### SUMMARY OF THE INVENTION

The present invention provides a composite plate, comprising a composite layer made of mixed sawdust and plastic. The raw material of the composite layer further comprises cullet, which is mixed with the sawdust and the thermoplastic to form the composite layer.

The composite plate according to the present invention may comprise two or more of the composite layers. The compositions and the proportions of each composition in each composite layer may be different.

In a preferred embodiment, the plate comprises a first surface layer bonded with one surface of the composite layer. Further, the plate further comprises a second surface layer bonded with the other surface of said composite layer.

The plate according to the present invention can be further processed into arc shape or wave shape, or other desired shapes.

The composite plate can be produced by carrying out the present invention which can utilize numerous recycled waste plastic, wood, and fibre without requiring any adhesive. Therefore, the production cost is reduced and the cyclic utilization of the resource is achieved to improve the environment protection.

### BRIEF DESCRIPTION OF THE DRAWINGS

The present invention will be described in detail with reference to the drawings below.

FIG. 1 is an illustration view of the composite plate of the present invention;

FIG. 2 is an illustration view of the composite plate according to another embodiment of the present invention;

FIG. 3 is an illustration view of the composite plate according to still another embodiment of the present invention;

FIG. 4 is an illustration view of the composite plate according to still another embodiment of the present invention;

FIG. 5 is an illustration view of the composite plate processed into wave shape according to the present invention; and

FIG. 6 is an illustration view of the composite plate processed into wave shape according to the present invention.

### DETAILED DESCRIPTION OF THE INVENTION

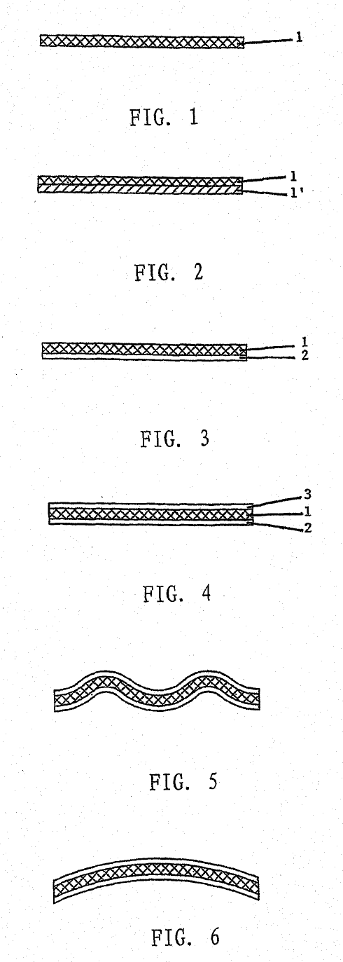

As illustrated in FIG. 1, the composite plate according to the present invention consists of a single composite layer 1. The composite layer 1 comprises a mixture of sawdust and plastic, the raw material of which can be all kinds of recycled waste wood and waste plastic. The plastic can be thermoplastic of any type. During the processing, the melted plastic is mixed with the sawdust. After the cooling and shaping of the plastic, the sawdust and the plastic are bonded together uniformly and firmly without requiring any additional adhesive. The mixing proportion of the plastic and the sawdust can be determined according to specific circumstances.

A wide range of weight percentage ration of sawdust and thermoplastic can be used in the composite plate of the present invention. For example, for a typical composite plate used as flooring, the weight ration of sawdust to thermoplastic can be in the range of 30/70 to 70/30, preferably 45/55 to 55/45. In one embodiment of the present invention, the weight ration of sawdust and thermoplastic in a composite plate is 50/50. For a composite plate used as wall cladding, the weight ration of sawdust to thermoplastic can be in the range of 95/5 to 70/30. In one embodiment of the present invention, the weight ration of sawdust and thermoplastic in a composite plate is 90/10. For other applications, the sawdust/thermoplastic ration can be as low as 5/95, or even lower, or higher than 95/5 as long as the thermoplastic can hold the sawdust.

The raw material for the composite layer 1 can comprise all kinds of recycled waste glass and/or fibre. The melted plastic is mixed with broke cullet and sawdust. After the cooling and shaping, the plastic, the cullet and the sawdust are bonded together uniformly and firmly to form a composite plate. Similarly, the plate does not need any additional adhesive.

The composite plate of the present invention can also contain two or more composite layers. The composite plate illustrated in FIG. 3 includes a composite layer 1 and a composite layer 1′.

Different composite layers can have different compositions. For example, the composite layer 1 can consist of sawdust and plastic, and the composite layer 1′ can consist of saw dust, cullet and plastic. Alternatively, the compositions of each composite layer are the same, and the proportion of each composition is different. In a preferred embodiment, the plastic in the composite layer 1 and the plastic in the composite layer 1′ are of different types. In another preferred embodiment, the plastic in the composite layer 1 and the plastic in the composite layer 1′ have different colors, thereby the two outer surfaces of the composite plate will present different colors.

The various composite layers described above can be further bonded with other surface layers to form a composite plate. In the embodiment shown in FIG. 5, the composite plate comprises two layers, i.e., a first surface layer 2 and a composite layer 1. The first surface layer 2 can be made of thermoplastic. In the embodiment shown in FIG. 6, the composite plate comprises three layers, i.e., a first surface layer 2, a composite layer 1 and a second surface layer 3. The composite layer 1 is disposed between the two surface layers. The first surface layer 2 and the second surface layer 3 are made of thermoplastic. The surface layers can be bonded to the surfaces of the composite layer without requiring any additional adhesive when the plastic of the composite layer is still in a melted state. In addition, the composite layers bonded with the surface layers can be two or more as described above. The outer surface(s) of the plastic surface layer(s) can be molded with patterns.

The composite plate according to the present invention can be subjected to spray paint or powder to the outer surfaces of the composite layer or the outer surface(s) of the surface layer(s), so as to obtain desired colors.

The composite plate can be made in plate shape as shown in FIGS. 1, 2, 3 and 4, or in wave type as shown in FIG. 5, or in arc shape as shown in FIG. 6 as desired, wherein the amplitude of the wave and the magnitude of the radian are not limited thereto.

Although the present invention has been described in detail with reference to a few embodiments thereof, various modifications and changes can be made by those skilled in the art without departing from the principles and spirit of the present invention.

What is claimed is:

1. A composite plate comprising a composite layer made of mixed sawdust and thermoplastic.

2. The composite plate according to claim 1, characterized in that, the raw material of said composite layer further comprises cullet, which is mixed with said saw dust and said thermoplastic to form said composite layer.

3. The composite plate according to claim 1, characterized in that, the composite plate comprises two or more said composite layers.

4. The composite plate according to claim 3, characterized in that, the plastics in said different composite layers are of different types.

5. The composite plate according to claim 3, characterized in that, the plastics in said different composite layers have different colors.

6. The composite plate according to claim 1, characterized in that, outer surfaces of said composite plate are subjected to spray paint or powder.

7. The composite plate according to claim 1, characterized in that, said plate further comprises a first surface layer bonded with one surface of said composite layer.

8. The composite plate according to claim 7, characterized in that, said plate further comprises a second surface layer bonded with the other surface of said composite layer.

9. The composite plate according to claim 7, characterized in that, said first surface layer is made of thermoplastic.

10. The composite plate according to claim 9, characterized in that, the outer surface of the first surface layer of said plate is processed with patterns.

11. The composite plate according to claim 1, characterized in that, said plate is processed into arc shape or wave shape.

12. The composite plate according to claim 2, characterized in that, the composite plate comprises two or more said composite layers.

13. The composite plate according to claim 12, characterized in that, the plastics in said different composite layers are of different types.

14. The composite plate according to claim 12, characterized in that, the plastics in said different composite layers have different colors.

15. The composite plate according to claim 2, characterized in that, outer surfaces of said composite plate are subjected to spray paint or powder.

16. The composite plate according to claim 2, characterized in that, said plate further comprises a first surface layer bonded with one surface of said composite layer.

17. The composite plate according to claim 16, characterized in that, said plate further comprises a second surface layer bonded with the other surface of said composite layer.

18. The composite plate according to claim 8, characterized in that, said second surface layer is made of thermoplastic.

19. The composite plate according to claim 18, characterized in that, the outer surface of the second surface layer of said plate is processed with patterns.

20. The composite plate according to claim 2, characterized in that, said plate is processed into arc shape or wave shape.
